(19) United States
(12) Patent Application Publication
(10) Pub. No.: US 2025/0290902 A1
(43) Pub. Date: Sep. 18, 2025

(54) METHOD FOR DETECTING ASIATICOSIDE AND MADECASSOSIDE IN COSMETICS

(71) Applicants: SH Inst Of Quality Inspection & Technical Research, Shanghai (CN); Shanghai Qingpu Inst for Food and Drug Control, Shanghai (CN); SH Jiading Food and Drug Inspection Testing Center, Shanghai (CN); Shanghai Jinshan Inst for Food and Drug Control, Shanghai (CN)

(72) Inventors: Yaobin ZHOU, Shanghai (CN); Hu WANG, Shanghai (CN); Lei NIE, Shanghai (CN); Wanlong ZHAO, Shanghai (CN); Chengming CAO, Shanghai (CN); Xiaojun NING, Shanghai (CN); Caili LIU, Shanghai (CN); Haihuan ZHANG, Shanghai (CN); Xinyuan FU, Shanghai (CN); Di WU, Shanghai (CN); Zelin ZHOU, Shanghai (CN); Qianru YANG, Shanghai (CN)

(73) Assignees: SH Inst Of Quality Inspection & Technical Research, Shanghai (CN); Shanghai Qingpu Inst for Food and Drug Control, Shanghai (CN); SH Jiading Food and Drug Inspection Testing Center, Shanghai (CN); Shanghai Jinshan Inst for Food and Drug Control, Shanghai (CN)

(21) Appl. No.: 19/058,036

(22) Filed: Feb. 20, 2025

(30) Foreign Application Priority Data
Mar. 18, 2024 (CN) 202410306153.2

(51) Int. Cl. G01N 30/06; G01N 1/40; G01N 30/54; G01N 30/56; G01N 30/74

(52) U.S. Cl. CPC G01N 30/06; G01N 1/4055; G01N 30/54; G01N 30/56; G01N 30/74; G01N 2001/4061; G01N 2030/562

(57) ABSTRACT

Provided is a method for detecting asiaticoside and madecassoside in cosmetics. Asiaticoside and madecassoside are extracted from cosmetics using a mixed extraction solvent of methanol and acetonitrile, and the asiaticoside and the madecassoside are detected by high performance liquid chromatography (HPLC). By controlling chromatographic conditions and selecting a mobile phase with a specific composition, the asiaticoside and the madecassoside in cosmetics can be assayed.

### CROSS REFERENCE TO RELATED APPLICATION

This patent application claims the benefit and priority of Chinese Patent Application No. 202410306153.2 filed with the China National Intellectual Property Administration on Mar. 18, 2024, the disclosure of which is incorporated by reference herein in its entirety as part of the present application.

### TECHNICAL FIELD

The present disclosure relates to the technical field of quality analysis of cosmetics, in particular to a method for detecting asiaticoside and madecassoside in cosmetics.

### BACKGROUND

Centella asiatica extracts added to cosmetics make it possible to resist oxidation, fade melanosis, inhibit free radicals, resist allergies, improve metabolism, and make skin smooth, tender, whitening and bright. The Centella asiatica extract is mainly composed of asiaticoside and madecassoside. At present, a plurality of cosmetics products on the market allege to have added Centella asiatica extract, but whether it is added and the amount of addition remain unknown due to a lack of detection methods. Therefore, it is particularly necessary to design a method for detecting asiaticoside and madecassoside in cosmetics.

### SUMMARY

In order to overcome the problem of the prior art, the present disclosure provides a method for detecting asiaticoside and madecassoside in cosmetics. The method makes it possible to accurately determine an addition amount of the asiaticoside and the madecassoside in cosmetics, and the method has advantages of simple pretreatment, high separation efficiency, high accuracy and high precision.

The present disclosure provides a method for detecting asiaticoside and madecassoside in cosmetics, including the following steps:
step 1, preparing a reference solution and standard working solutions;
step 2, preparing a test sample solution; and
step 3, detecting the asiaticoside and the madecassoside by high performance liquid chromatography (HPLC), and analyzing detection results,
wherein the HPLC is conducted under the following conditions:
in a chromatographic column, octadecylsilane chemically bonded silica is used as a packing; the chromatographic column is at a column temperature of 30-40° C.; a mobile phase is a mixture of methanol, acetonitrile and water, and a volume ratio of the methanol, the acetonitrile and the water is in a range of 1.5-3.0:1.0-2.5:6; and the mobile phase has a flow rate of 0.5-1.5 mL/min.

In some embodiments, in the mobile phase, the volume ratio of the methanol, the acetonitrile and the water is in a range of (1.8-2.2):(1.8-2.2):6.

In some embodiments, in the mobile phase, the volume ratio of the methanol, the acetonitrile and the water is in a range of 2:2:6.

In some embodiments, the flow rate is 1.0±0.5 mL/min.

In some embodiments, in step 1, the reference solution is prepared by a process comprising: accurately weighing equal quantities of reference standard samples of the asiaticoside and the madecassoside in a volumetric flask, and diluting with the methanol to volume to prepare the reference solution, with a concentration of the asiaticoside and a concentration of the madecassoside both of 1.0 mg/mL for later use; and
the standard working solutions are prepared by a process comprising: diluting the reference solution by an extraction solvent to obtain ready-to-use standard working solutions with a series of concentrations of 5 μg/mL, 10 μg/mL, 20 μg/mL, 50 μg/mL, and 100 μg/mL, wherein the extraction solvent is a mixture of acetonitrile and methanol, and a volume ratio of the acetonitrile to the methanol is in a range of 1:1-9.

In some embodiments, in step 2, the test sample solution is prepared by a process comprising: quantitatively weighing a test sample and putting into a graduated centrifuge tube, and adding a sample extraction solvent to obtain a mixture; subjecting the mixture to extraction by vortex oscillation and ultrasonic in water bath, and cooling a resulting system to ambient temperature; diluting a resulting cooled system by using the sample extraction solvent to volume, and centrifuging to collect a supernatant for later use, wherein the sample extraction solvent is a mixture of acetonitrile and methanol, and a volume ratio of the acetonitrile to the methanol is in a range of 1:1-9.

In some embodiments, in the extraction solvent, the volume ratio of the acetonitrile to the methanol is in a range of 1:(4-9).

In some embodiments, the ultrasonic in water bath is conducted for 20-30 min.

In some embodiments, the supernatant is filtered through a 0.22 μm polytetrafluoroethylene (PTFE) filter membrane before detection.

In some embodiments, in the HPLC, a detector is selected from the group consisting of an ultraviolet (UV) detector and a diode array detector; and the detector is operated at a detection wavelength of 205±10 nm.

In some embodiments, an injection volume is in a range of 1-20 μL.

In some embodiments, in the mobile phase, the volume ratio of the acetonitrile, the methanol and the water is 2:2:6.

In some embodiments, an elution method in the HPLC is an isocratic elution.

In some embodiments, in step 3, a standard curve of peak area versus mass concentration is plotted, wherein the mass concentration of the standard working solutions of mixed madecassoside and asiaticoside is as an abscissa; and content of the madecassoside and the asiaticoside in a sample is quantified by an external standard method.

In some embodiments, the cosmetics are made into one selected from the group consisting of lotions, creams, and emulsions.

Compared with the prior art, some embodiments of the present disclosure have the following beneficial effects: the method for detecting asiaticoside and madecassoside in cosmetics provided by the present disclosure makes it possible to solve the problem of determining the addition amount of asiaticoside and madecassoside in cosmetics, and the method has advantages of simple pretreatment, high separation efficiency, good repeatability, high accuracy and high precision. Moreover, the method has short detection time, which is suitable for batch detection of asiaticoside and madecassoside in cosmetics. The method can be used in conjunction with the General Rules for Cosmetic Labeling, which is of great significance to the market supervision of cosmetics.

### BRIEF DESCRIPTION OF THE DRAWINGS

FIG. 1 shows a chromatogram under the condition that a mobile phase composition is condition A in Example 1;

FIG. 2 shows a chromatogram under the condition that a mobile phase composition is condition B in Example 1;

FIG. 3 shows a chromatogram under the condition that a mobile phase composition is condition C in Example 1;

FIG. 4 is a schematic diagram of extraction efficiency under different volume ratios of methanol to acetonitrile in Example 2; and

FIG. 5 shows a schematic diagram of extraction efficiency under different sonication time in Example 3.

### DETAILED DESCRIPTION OF THE EMBODIMENTS

The present disclosure will be further described below with reference to specific examples. It should be understood that these examples are only intended to describe the present disclosure, rather than to limit the scope of the present disclosure. In addition, it should be understood that various changes or modifications may be made on the present disclosure by those skilled in the art after reading the content of the present disclosure, and these equivalent forms also fall within the scope defined by the appended claims of the present disclosure.

The present disclosure provides a method for detecting asiaticoside and madecassoside in cosmetics, including the following steps:
step 1, preparing a reference solution and standard working solutions: accurately weighing equal quantities of reference standard samples of the asiaticoside and the madecassoside in a volumetric flask, and diluting with methanol to volume to prepare the reference solution, with a concentration of 1.0 mg/mL for later use; and diluting the reference solution by an extraction solvent to obtain ready-to-use standard working solutions with a series of concentrations of 5 μg/mL, 10 μg/mL, 20 μg/mL, 50 μg/mL, and 100 μg/mL, where the extraction solvent is a mixture of acetonitrile and methanol, and a volume ratio of the acetonitrile to the methanol is in a range of 1:(1-9);
step 2, preparing a test sample solution: quantitatively weighing a test sample in a graduated centrifuge tube, and adding a sample extraction solvent to obtain a mixture; subjecting the mixture to extraction by vortex oscillation and ultrasonic in water bath, and cooling a resulting system to room temperature; diluting a resulting cooled system by using the sample extraction solvent to volume, and centrifuging to collect a supernatant for later use, where the sample extraction solvent is a mixture of acetonitrile and methanol, and a volume ratio of the acetonitrile to the methanol is in a range of 1:(1-9); and
step 3, detecting the asiaticoside and the madecassoside by HPLC; after detection, plotting a standard curve of peak area versus mass concentration, where the mass concentration of standard working solutions of mixed madecassoside and asiaticoside are used as an abscissa; quantifying content of the madecassoside and the asiaticoside in a sample by an external standard method, and analyzing detection results; where chromatographic conditions are as follows: in a chromatographic column, octadecylsilane chemically bonded silica is used as a packing; the chromatographic column is at a temperature of 30-40° C.; a mobile phase is a mixture of acetonitrile, methanol and water, and a volume ratio of the acetonitrile, the methanol and the water is in a range of (1.5-3.0):(1.0-2.5):6; and the mobile phase has a flow rate of 0.5-1.5 mL/min; and an injection volume is 1-20 μL.

In some embodiments, the volume ratio of the acetonitrile to the methanol in the extraction solvent is in a range of 1:(4-9).

In some embodiments, the ultrasonic in water bath is conducted for 20-30 min.

In some embodiments, an elution method in the HPLC is an isocratic elution.

In some embodiments, in step 3, in the mobile phase, the volume ratio of the acetonitrile, the methanol and the water is in a range of (1.8-2.2):(1.8-2.2):6, and preferably 2:2:6.

In some embodiments, in the HPLC, a detector is selected from the group consisting of a UV detector and a diode array detector. In some embodiments, the detector is operated at a detection wavelength of 205±10 nm, and preferably 205 nm.

In some embodiments, the mobile phase has a flow rate of 1.0 mL/min. In some embodiments, the injection volume is 20 μL.

In some embodiments, the cosmetics is made into one selected from the group of lotions, creams, and emulsions.

In the following examples, the reference solution and standard working solutions used were prepared as follows: 10.0 mg each of the reference solutions of asiaticoside and madecassoside are accurately weighed in a 10 mL volumetric flask, and diluted with methanol to volume. A 1.0 mg/mL standard stock solution was obtained, and stored in a refrigerator at −20° C.

The standard working solution of a mixture of the asiaticoside and the madecassoside: the standard stock solution was diluted by an extraction solvent (methanol-acetonitrile=8:2 (v:v)) into ready-to-use standard working solutions with a series of concentrations 5 μg/mL, 10 μg/mL, 20 μg/mL, 50 μg/mL, and 100 μg/mL.

### Example 1

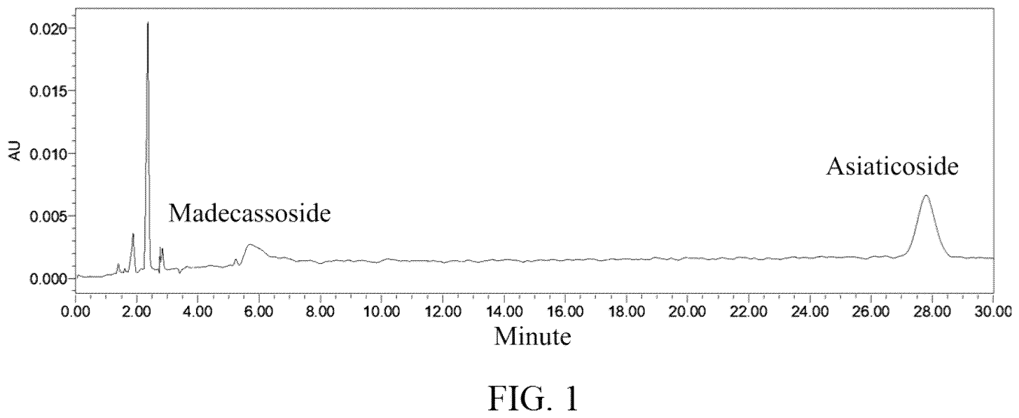

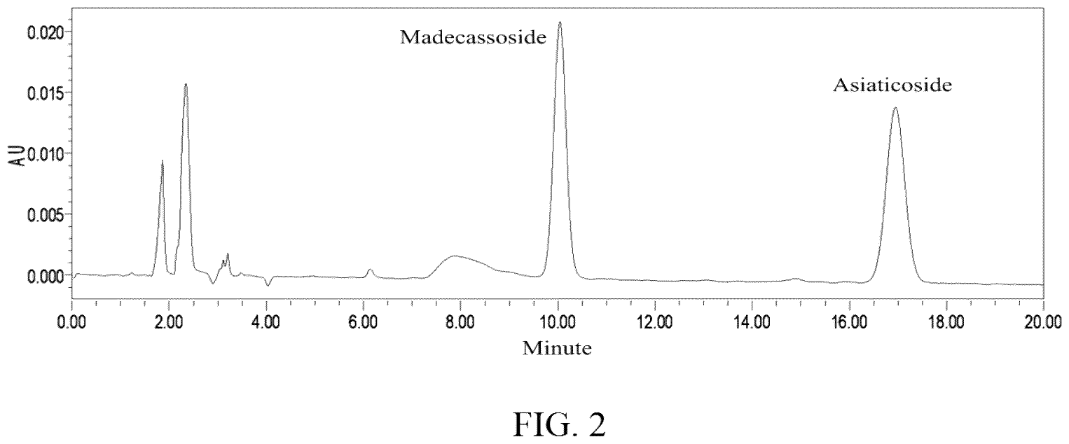

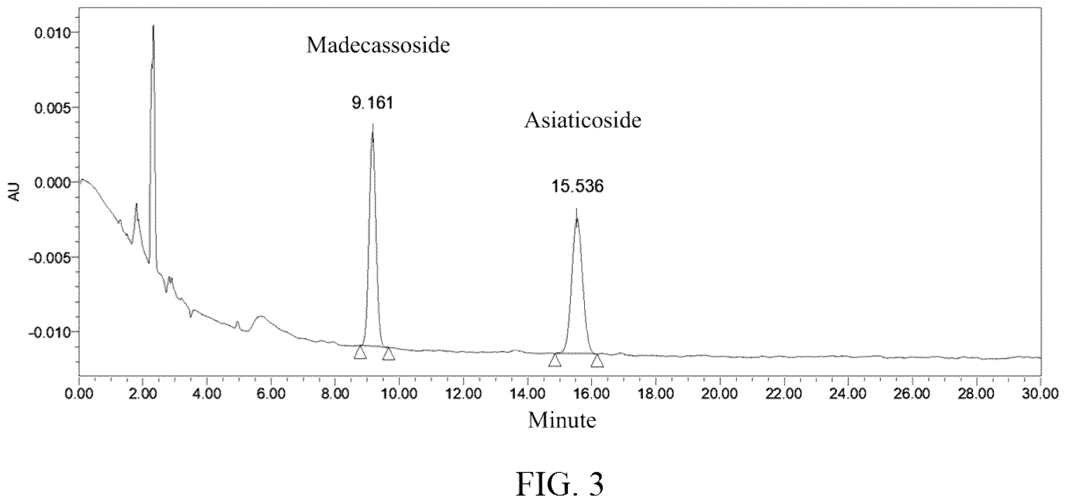

In this example, the composition of the mobile phase was extensively screened. When the mobile phase was a mixture of two selected from the group consisting of methanol, water, and acetonitrile, peaks appeared in a short time, and the separation efficiency of asiaticoside and madecassoside was poor. For the selection of mobile phase for the detection of cosmetics, if the peak appears too early, the sample to be tested will be substantially interfered. Therefore, it is not suitable for the actual detection of cosmetics samples that the peak appears too early. Therefore, in this example, a mixed solution composed of different proportions of methanol, water, and acetonitrile was further designed as a mobile phase to detect a mixed standard working solution of asiaticoside and madecassoside by HPLC. Three different mobile phase conditions were provided in this example. Condition A was methanol:water:acetonitrile=1.0:3.0:6.0; condition B was methanol:water:acetonitrile=2.0:2.0:6.0; and condition C was methanol:water:acetonitrile=3.0:1.0:6.0. The detection results are shown in FIG. 1 to FIG. 3.

According to the results of FIG. 1 to FIG. 3, although condition A can achieve separation, the detection time required is too long; thus, condition A is not suitable for the detection of large quantities of samples. Both condition B and condition C can achieve better separation. When condition B is used, the response is better, the peak time is appropriate, and asiaticoside and madecassoside can be well separated. Therefore, it was ultimately confirmed that the volume ratio of methanol, acetonitrile and water was 2:2:6 as the final elution condition, with a retention time of around 10 min for madecassoside and around 17 min for asiaticoside. Under this mobile phase, madecassoside and asiaticoside can be completely separated, and the separation can be completed within 20 min, which is suitable for rapid analysis of large-scale samples. Moreover, under this mobile phase, the detection was repeated for three times with good repeatability.

Therefore, in the subsequent examples, the chromatographic conditions were as follows: a chromatographic column was Agilent XDB-C18, 4.6*250 mm, 5 μm; a column temperature was 35° C.; a mobile phase was a mixture of acetonitrile, methanol and water, and a volume ratio of acetonitrile, methanol and water was 2:2:6; a flow rate was 1.0 mL/min; a detector was a diode array detector, and the detector was conducted at a detection wavelength of 205 nm; and an injection volume was 20 μL.

### Example 2

### Screening of Extraction Solvents

Asiaticoside and madecassoside are freely soluble in water and methanol, but for cream and emulsion cosmetics, pure methanol solvent has a poor demulsification effect, resulting in that the sample solution containing the target compound is not clear and the chromatographic column is easily blocked during instrumental analysis. Therefore, in the present disclosure, acetonitrile with stronger demulsification effect was added into methanol for mixed extraction.

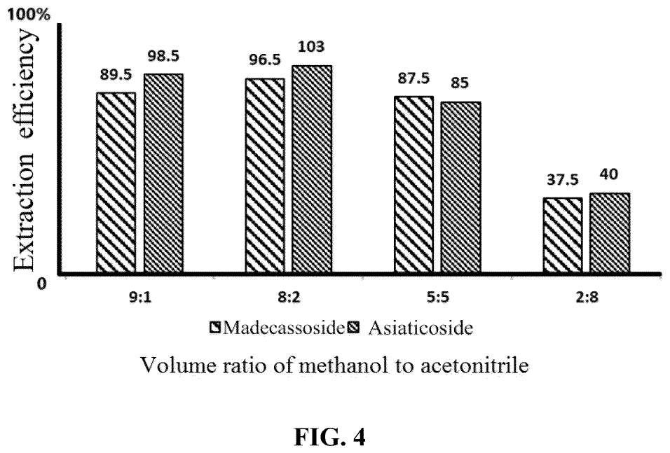

In this example, the extraction efficiency of different ratios of methanol and acetonitrile was investigated by adding a target mixture to cream samples with complex matrices among cosmetics. The results are shown in FIG. 4. When the volume ratio of acetonitrile to methanol is 1:(1-9), the extraction efficiency is excellent; when the volume ratio of acetonitrile to methanol is 1:4, the extraction efficiency is the best; and when the volume ratio of ethanol to methanol is 4:1, it exhibits poor extraction efficiency. Therefore, in the subsequent examples, the extraction solvent with the volume ratio of acetonitrile to methanol of 1:4 was used as the extraction solvent for creams and emulsions.

### Example 3

### Screening of Sonication Time

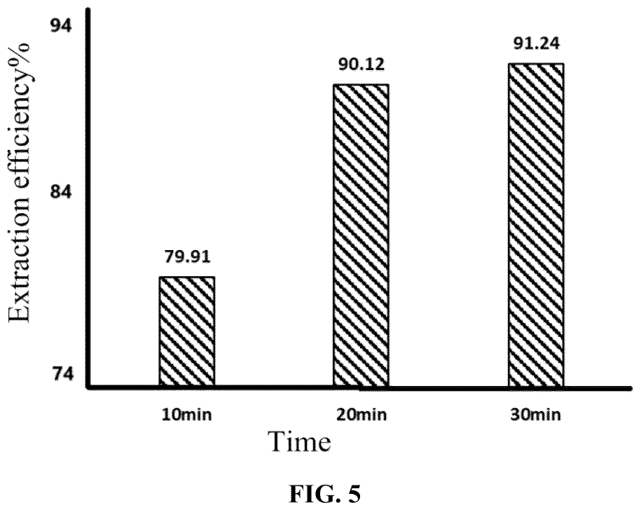

In this example, the target mixture was added to the blank cream cosmetics, and a resulting mixture was subjected to ultrasonic extraction by the extraction solvent. Different ultrasonic extraction time was investigated. The extraction results are shown in FIG. 5. From FIG. 5, it can be seen that the extraction efficiency increases very little when the sonication is conducted for more than 20 min. Therefore, in the subsequent examples of cosmetics detection, the ultrasonic extraction time was selected as 20 min.

### Example 4

### Limit of Detection (LOQ), Linearity, and Limit of Quantitation (LOQ)

In this example, the standard working solutions of the mixed madecassoside and asiaticoside were injected for detection. A standard curve of peak area versus mass concentration is plotted, wherein mass concentrations of the standard working solutions of mixed madecassoside and asiaticoside are as an abscissa. The results show that madecassoside and asiaticoside were linear in the concentration range of 5-100 μg/mL. The linear regression equation of madecassoside was Y=−3.35*10³X+5.04*10³, and the linear correlation coefficient was 0.9998. The linear regression equation of asiaticoside was Y=−1.41*10³X+4.94*10³, and the linear correlation coefficient was 0.9992. The LOD and LOQ of madecassoside and asiaticoside were determined to be 0.0015% (w/w) and 0.005% (w/w), respectively, using a 3-fold signal-to-noise ratio as LOD and a 10-fold signal-to-noise ratio as LOQ and combining with the spike-and-recovery of the sample.

### Example 5

### Recovery Rate and Precision

In this example, three representative negative blank sample matrices (lotions, creams, and emulsions) were selected and added with low, medium and high concentration levels (w/w) (0.005%, 0.01% and 0.05%), respectively. Each addition level was detected in sextuplicate. Their recovery rate and precision results are shown in Tables 1 and 2.

TABLE 1
Recovery and precision experiment
results of madecassoside (n = 6)

| Sample | Addition/ | Measured | Recovery | RSD |
|---|---|---|---|---|
| name | (%) | value/(%) | rate/% | (%) |
| Lotion | 0.005 | 0.00481 | 96.2 | 3.59 |
| | 0.01 | 0.00968 | 96.8 | 4.28 |
| | 0.05 | 0.05241 | 105 | 3.22 |
| Cream | 0.005 | 0.00526 | 105 | 1.57 |
| | 0.01 | 0.00997 | 99.7 | 3.96 |
| | 0.05 | 0.04143 | 82.8 | 1.99 |
| Emulsion | 0.005 | 0.00451 | 90.2 | 2.74 |
| | 0.01 | 0.00835 | 83.5 | 1.86 |
| | 0.05 | 0.04578 | 91.6 | 0.94 |

TABLE 2
Recovery and precision experiment results of asiaticoside (n = 6)

| Sample | Addition/ | Measured | Recovery | RSD |
|---|---|---|---|---|
| name | (%) | value/(%) | rate/% | (%) |
| Lotion | 0.005 | 0.00519 | 104 | 3.54 |
| | 0.01 | 0.01026 | 103 | 2.54 |
| | 0.05 | 0.05289 | 106 | 3.23 |
| Cream | 0.005 | 0.00498 | 99.1 | 1.28 |
| | 0.01 | 0.00970 | 97.0 | 3.71 |
| | 0.05 | 0.04382 | 87.6 | 3.51 |
| Emulsion | 0.005 | 0.00480 | 96.0 | 3.77 |
| | 0.01 | 0.00966 | 96.6 | 3.36 |
| | 0.05 | 0.04955 | 99.1 | 1.28 |

From the results of Tables 1 and 2, it can be seen that the spike-and-recovery rate of lotions, creams, and emulsions falls within 82.8-106%, and the relative standard deviation is <5%. From this, it can be seen that this method has high accuracy for the detection of madecassoside and asiaticoside in lotions, creams, and emulsions.

### Example 6

### Cosmetics Detection

Ten cosmetics labeled with Centella asiatica extract on the market were selected for detection according to the foregoing method, including the following steps:

(1) 10 mg of the asiaticoside reference substance and 10 mg of the madecassoside reference substance were accurately weighed in a 10 mL volumetric flask, and then diluted with methanol to volume. A resulting 1.0 mg/mL standard stock solution was stored in a refrigerator at −20° C.

Standard working solutions of the mixed asiaticoside and madecassoside: the foregoing standard stock solution was formulated into ready-to-use standard working solutions with a series of concentrations 5 μg/mL, 10 μg/mL, 20 μg/mL, 50 μg/mL, and 100 μg/mL using an extraction solvent (methanol-acetonitrile=8:2 (v:v)).

(2) 1 g (accurate to 0.001 g) of the cosmetics sample to be tested was weighed accurately in a 10 mL graduated centrifuge tube, mixed with 7 mL of a sample extraction solvent. A resulting mixture was vortex oscillated for 1 min, sonicated in water bath for 20 min, cooled to room temperature, and diluted with the sample extraction solvent (methanol-acetonitrile=8:2 (v:v)) to volume. Then a resulting system was centrifuged at 10,000 r/min for 10 min to collect a supernatant, and the supernatant was filtered through a 0.22 μm PTFE filter membrane for later use.

(3) The asiaticoside and madecassoside were detected by HPLC. After detection, a standard curve of peak area versus mass concentration was plotted using a mass concentration of the standard working solution of the mixed madecassoside and asiaticoside as an abscissa, and content of the asiaticoside and the madecassoside in the sample was quantified by an external standard method to analyze the detection results.

The chromatographic conditions were as follows: a chromatographic column was Agilent XDB-C18, 4.6*250 mm, 5 μm; the chromatographic column was at a column temperature of 35° C.; a mobile phase was a mixture of acetonitrile, methanol and water, and a volume ratio of acetonitrile, methanol and water was 2:2:6; a flow rate was 1.0 mL/min; a detector was a diode array detector, and the detector was conducted at a detection wavelength of 205 nm; and an injection volume was 20 μL.

The detection results are shown in Table 3, in which the content of asiaticoside and madecassoside ranges from 0.0223% to 0.202%. Asiaticoside and madecassoside were not detected in two cosmetics samples labeled with Centella asiatica extract, and asiaticoside and madecassoside were detected in ten cosmetics samples that are not labeled with Centella asiatica extract.

TABLE 3
Detection results of cosmetics samples

| | Madecassoside | Asiaticoside |
|---|---|---|
| Sample name | content (%) | content (%) |
| Skin refinisher | 0.0223 | 0.0451 |
| Plant extract lady ointment | Not detected | Not detected |
| Lotion | Not detected | Not detected |
| Foundation emulsion | 0.0525 | 0.0684 |
| Regenerating repair lotion | 0.121 | 0.0985 |
| Beauty skin essence emulsion | 0.0651 | 0.202 |
| Rejuvenating emulsion | 0.121 | 0.126 |
| Repair cream | 0.0254 | 0.0325 |
| Repair emulsion | 0.0584 | 0.0612 |
| Chamomile repair cream | 0.0265 | 0.0312 |

The above descriptions are merely preferred embodiments of the present disclosure and do not constitute a limitation on the patent scope of the present disclosure. Any equivalent structure or equivalent process change made by using the specification and the drawings of the present disclosure should still fall within the scope of the present disclosure.

What is claimed is:

1. A method for detecting asiaticoside and madecassoside in cosmetics, comprising:
step 1, preparing a reference solution and standard working solutions;
step 2, preparing a test sample solution; and
step 3, detecting the asiaticoside and the madecassoside by high performance liquid chromatography (HPLC), and analyzing detection results,
wherein the HPLC is conducted under the following conditions:
in a chromatographic column, octadecylsilane chemically bonded silica is used as a packing;
the chromatographic column is at a column temperature of 30-40° C.;
a mobile phase is a mixture of methanol, acetonitrile and water, and a volume ratio of the methanol, the acetonitrile and the water is in a range of 1.5-3.0:1.0-2.5:6; and
the mobile phase has a flow rate of 0.5-1.5 mL/min.

2. The method of claim 1, wherein in step 1,
the reference solution is prepared by a process comprising: weighing equal quantities of reference standard samples of the asiaticoside and the madecassoside in a volumetric flask, and diluting with the methanol to volume to prepare the reference solution, with a concentration of the asiaticoside and a concentration of the madecassoside both of 1.0 mg/mL; and
the standard working solutions are prepared by a process comprising: diluting the reference solution by an extraction solvent to obtain ready-to-use standard working solutions with a series of concentrations of 5 μg/mL, 10 μg/mL, 20 μg/mL, 50 μg/mL, and 100 μg/mL, wherein the extraction solvent is a mixture of acetonitrile and methanol, and a volume ratio of the acetonitrile to the methanol is in a range of 1:1-9.

3. The method of claim 1, wherein in step 2, the test sample solution is prepared by a process comprising:
quantitatively weighing a test sample and putting into a graduated centrifuge tube, and adding a sample extraction solvent to obtain a mixture;
subjecting the mixture to extraction by vortex oscillation and ultrasonic in water bath, and cooling a resulting system to ambient temperature; and
diluting a resulting cooled system by using the sample extraction solvent to volume, and centrifuging to collect a supernatant,
wherein the sample extraction solvent is a mixture of acetonitrile and methanol, and a volume ratio of the acetonitrile to the methanol is in a range of 1:1-9.

4. The method of claim 2, wherein in the extraction solvent, the volume ratio of the acetonitrile to the methanol is in a range of 1:4-9.

5. The method of claim 3, wherein in the sample extraction solvent, the volume ratio of the acetonitrile to the methanol is in a range of 1:4-9.

6. The method of claim 3, wherein the ultrasonic in water bath is conducted for 20-30 min.

7. The method of claim 3, wherein the supernatant is filtered through a 0.22 μm polytetrafluoroethylene (PTFE) filter membrane before detection.

8. The method of claim 1, wherein in the HPLC, a detector is selected from the group consisting of an ultraviolet (UV) detector and a diode array detector; and the detector is operated at a detection wavelength of 205±10 nm.

9. The method of claim 1, wherein an injection volume is in a range of 1-20 μL.

10. The method of claim 1, wherein in step 3, a standard curve of peak area versus mass concentration is plotted, wherein the mass concentration of the standard working solutions of mixed madecassoside and asiaticoside is as an abscissa; and content of the madecassoside and the asiaticoside in a sample is quantified by an external standard method.

11. The method of claim 1, wherein the cosmetics are made into one selected from the group consisting of lotions, creams, and emulsions.
